(19) United States
(12) Patent Application Publication
(10) Pub. No.: US 2010/0115149 A1
(43) Pub. Date: May 6, 2010

(54) System and method for digital signaling of computer headset connection status

(75) Inventor: Paul A. Ewer, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 10/308,540

(22) Filed: Dec. 2, 2002

(51) Int. Cl. G06F 3/00; G06F 1/32; G06F 21/00

(52) U.S. Cl. 710/19; 713/320; 726/26

(57) ABSTRACT

A system and method for automatic detection and signaling of the connection status of a headset used with telephony or other multimedia application software running on processor-based hosts using digital signaling are disclosed. The signaling system includes a signaling module for communicating with the host and a headset selectively in communication with the signaling module for use with the application software. The signaling module monitors the headset connection status, generates a status signal, and transmits the status signal to the host for determining the state of host and/or the application software. The signaling module may include a connection status detector and a status signal generating processor. A signal indicating that the headset is disconnected may pause or terminate an executing application or prevent the application from being executed. A signal indicating that the headset is connected may resume a paused application or allow the application to be executed.

### BACKGROUND OF THE INVENTION

1. Field of the Invention

The present invention relates generally to telephony and multimedia applications using personal computers or other processor-based hosts. More specifically, a system and method for automatic detection and signaling of the connection status of a headset used with telephony or other multimedia application software running on personal computers or other processor-based hosts using digital signaling are disclosed.

2. Description of Related Art

Telephone or computer headsets are used extensively, often by operators, customer service agents such as in call centers, and/or other professionals who frequently use telephones or computer telephony applications. The headset is typically connected to a base unit, i.e., the telephone or the computer, via a connector such as a Quick Disconnect™ (QD) connector in order to provide added convenience and operability. The QD connector may be a mechanical interconnect positioned between the headset and the base unit or between the headset and a telephone headset adapter connected to the base unit. The user may simply and quickly disconnect the headset at the QD connector rather than at the base unit so that the headset user does need not to remove the headset and can keep the headset on even when the user moves away from the base unit.

However, in certain circumstances, particularly in call centers, it is useful to automatically detect that the headset is no longer connected to the base unit. For example, it would be desirable to automatically avoid routing incoming telephone calls at customer service centers to customer service agents whose headsets have been disconnected from their telephones and automatically route such calls only to customer agents whose headsets are connected to their telephones.

Automatic call distribution (ACD) systems, provided in many telephone systems, are often able to detect whether the telephone headset is connected to or disconnected from the base telephone. In particular, the ACD system monitors the connection of the telephone headset either through the current drawn from or the voltage present at the headset interface. If the headset user disconnects the headset from the telephone system, the ACD system may be able to detect that the headset is disconnected and instructs the telephone system to perform any number of predetermined actions, e.g., activate a voice mail system to answer subsequent incoming calls or forward incoming calls to an available customer service agent.

As another example, where the QD connector is provided between the headset and the inline amplifier, the in-line amplifier is modified to detect a disconnection of the headset from the in-line amplifier at the QD connector and to emulate the effect of disconnecting the headset at the telephone. Thus, when the headset user disconnects the headset at the QD connector, the inline amplifier detects the disconnection, emulates the effect of disconnecting the headset, and causes the ACD system to detect the disconnection and to instruct the telephone system to perform the predetermined action(s).

Such ACD systems utilize telephone polling procedures to determine headset connection status and are thus limited to telephony use. However, headsets are not only used with telephony systems but are widely used in a variety of computer and other multimedia applications, particularly with the convergence of computer and telephony technologies. Examples of headsets designed to connect to computers or other processor-based hosts include those adapted for various applications such as computer telephony (generally referred to as softphones), voice recognition, language or speech learning, audio listening for music, training, video, etc., and video game systems.

However, conventional multimedia applications running on processor-based hosts do not provide automatic monitoring of the status of the headset used in connection with the multimedia applications to determine whether the headset has been disconnected from the host such as when the user leaves his office or workstation. For example, an application running on the host and communicating with the user through the headset does not automatically change states when the user disconnects the headset from the host. Rather, each application requires deliberate manual intervention by the user in order for the application to be informed of the disconnection and for the application to change its state.

Thus, what is needed is a system and method to automatically detect and to signal headset connection status to application software running on the host. Ideally, the system and method enable the host to automatically detect the headset connection status and enable application software running on the host to enter into desired states in response to changes in the headset connection status.

### SUMMARY OF THE INVENTION

A system and method for automatic detection and signaling of the connection status of a headset used with telephony or other multimedia application software running on personal computers or other processor-based hosts using digital signaling are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

The digital headset status signaling system includes a signaling module for communicating with the host and a headset selectively in communication with the signaling module for use with the application software executed on the host. The signaling module monitors the headset connection status, generates a status signal, and transmits the status signal to the host for determining the state of host and/or the application software. The headset may be connected to the signaling module via a quick disconnect connector. The signaling module may include a connection status detector and a status signal generating processor. The detector may actively poll the connector for status or passively monitor the status. The signaling module preferably communicates with the host via USB ports. A signal indicating that the headset is disconnected may pause or terminate an executing application or prevent the application from being executed. A signal indicating that the headset is connected may resume a paused application or allow the application to be executed.

The method for digitally signaling connection status of a headset to a processor-based host device generally comprises monitoring the headset connection status by a signaling module based on whether the headset is in communication with the signaling module, generating a digital headset status signal by a signal generating processor of the signaling module, and transmitting the digital headset status signal from the signaling module to the host device. The host device is responsive to the digital headset status signal for determining the state of the host and/or the application software.

In one preferred exemplary embodiment, the application software is a training application software running a training session on the host where training audio is fed to a trainee through the headset. The training session is referred to as being idle when the training session is not progressing. The session is in one of a number of possible states and makes state transitions based upon the received headset connection status signals. For example, when the host receives a digital headset status signal that indicates that the headset is disconnected, the session will be paused as the trainee is not following the session once the headset is disconnected. When the host receives a digital headset status signal that indicates that the headset is reconnected when the session is paused, the training session will restart to allow the trainee to complete the session from where the training session was paused.

In another preferred embodiment, the application software is a softphone application running on the host device and configured to handle telephone calls. The softphone application software is referred to as being idle when the softphone application is not handling a telephone call. The softphone is in one of a number of possible states and makes state transitions based upon the received headset connection status signals. For example, when the host receives a digital headset status signal that indicates that the headset is connected when the softphone is idle, the softphone application is placed in a state that allows the softphone application software to receive an incoming call. When the host receives a digital headset status signal that indicates that the headset is disconnected when the softphone is in the available state, the softphone transitions to a state in which the softphone may call a feature in the softphone application or call another application such as an answer phone or speaker phone application upon receiving an incoming call. When the host receives a digital headset status signal that indicates that the headset is disconnected when the softphone is in a state with a call in progress, the softphone transitions to a hold state that places the call in progress on hold. When the host receives a digital headset status signal that indicates that the headset is connected when the softphone is in a hold state, the softphone returns to the call-in-progress state.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like elements, and in which:

FIG. 1 is a block diagram illustrating an exemplary embodiment of a system for digital signaling of headset connection status to a host device;

FIG. 2 is a block diagram illustrating the system of FIG. 1 in more detail;

FIG. 3 is a state diagram illustrating exemplary states and state transitions for an application such as a training application, a voice recognition application, a music or other audio player application, a video game application, or a video player application, running on a processor-based host and responsive to changes in headset connection status;

FIG. 4 is a state diagram illustrating exemplary states and state transitions for a softphone at a call center running on a processor-based host and responsive to changes in headset connection status;

FIG. 5 is a flow chart illustrating an exemplary process for detecting and responding to changes in headset connection status by the host and the application running on the host;

FIG. 6 illustrates an example of a computer system that can be utilized with the various embodiments of method and processing described herein; and

FIG. 7 illustrates a system block diagram of the computer system of FIG. 6.

### DESCRIPTION OF SPECIFIC EMBODIMENTS

A system and method for automatic detection and signaling of the connection status of a headset used with telephony or other multimedia application software running on personal computers or other processor-based hosts using digital signaling are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

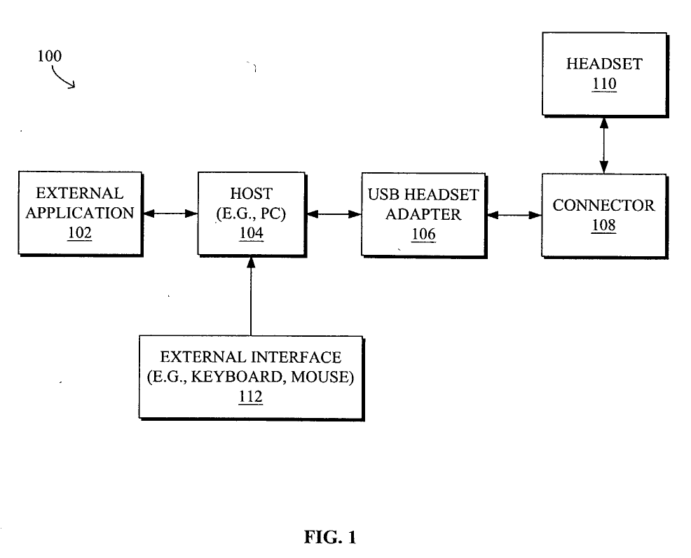

FIG. 1 is a block diagram illustrating an exemplary embodiment of a digital headset connection status signaling system 100 for digital signaling of the status of a headset 110 to a host device 104. As shown, the headset 110 is connected to the host device 104 via a connector 108 and a headset adapter 106, typically a USB (Universal Serial Bus) headset adapter. The connector 108 may be a quick disconnect (QD) device and preferably allows the headset user to quickly disconnect the headset 110 at the connector 108 rather than at the headset adapter 106 so that the user may easily and quickly disconnect the headset and leave the area without removing the headset 110. The connector 108 has a headset portion that is connected to the headset 110 and an adapter portion that is connected to the headset adapter 108. The headset portion and the adapter portion of the connector 108 are connected to and disconnected from each other so as to connect and disconnect the headset 110 and the headset adapter 106. It is noted that although the examples described herein utilize the connector 108 between the headset 110 and the adapter 106, as is preferred, the headset 110 may alternatively be directly connected to and disconnected from the adapter 106. In particular, the digital signaling taking place between the adapter 106 and the host 104 for automatic detection of the connection status of the headset 110 is similar regardless of whether the connector 108 is provided.

The headset 110 is preferably in communication with the host device 104 via the USB headset adapter 106 connected to a USB port of the host device 104. However, any other suitable communication port may be used for connecting the headset 110 to the host 104. In addition, although wired connections are typically and preferably employed, such as between the USB headset adapter 106 and the host 104 and between the adapter 106 and the headset 110, wireless connections may alternatively be employed. For example, the headset 110 may be a cordless headset in wireless communication with the adapter 106, e.g., using RF technology. The headset 110 can be selectively powered on or off and thus be selectively in communication with the adapter 106. Thus, the term “connection” utilized herein generally refers to both wired and wireless connections.

The host device 104 is generally any suitable processor-based device such as a personal computer (PC), a personal digital assistant (PDA), a digital music player (e.g., MP3 player), a video player (e.g., DVD player), a video game player, and a processor-based telephone. The host device 104 executes application software such as a telephony application software that uses the headset 110, for example, for receiving the user's voice as input and/or for outputting sounds to the user as output. When the user disconnects the headset 110 at the connector 108, the headset adapter 106 transmits a digital flag signal indicating a change in the headset connection status to the host 104 running the application software. Similarly, when the user reconnects the headset 110 at the connector 108, the headset adapter 106 transmits the flag signal to indicate a change in the headset connection status to the application software running on the host 104. Thus, as is evident, the adapter 106 functions at least in part as a headset connection status signaling module to the host 104.

As shown, the system 100 may additionally include any number of input interfaces 112, typically external interfaces such as keyboard and mouse as well as any number of external applications 102 such as a display, DVD player, CD-ROM drive, CD-RW drive, microphone, and speakers. Such input interfaces 112 and external applications 102 are well known in the art.

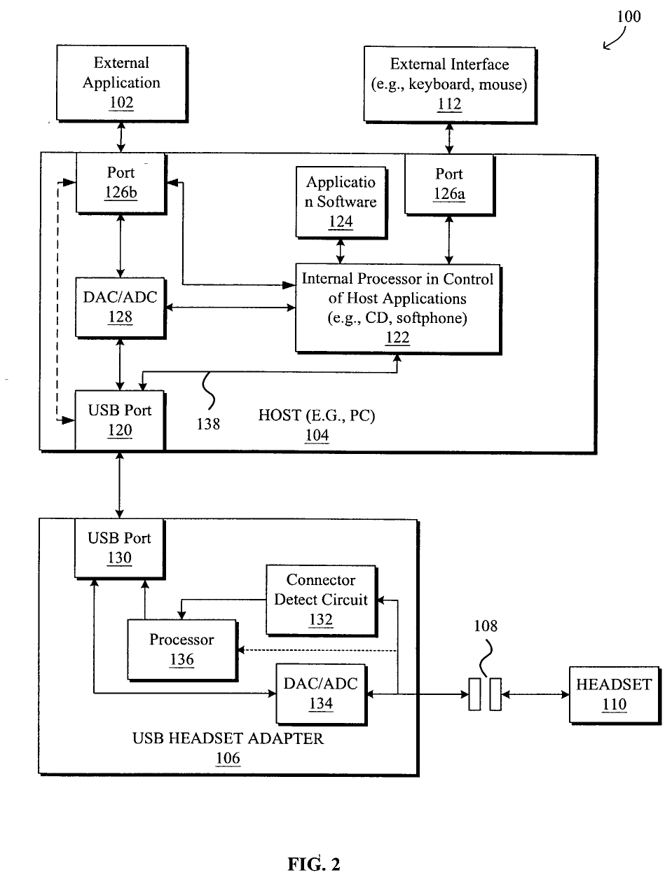

FIG. 2 is a block diagram illustrating the host PC 104 and the headset adapter 106 of the system 100 in more detail. The host 104 is generally shown and described as being a PC with a USB port 120 to which a USB headset adapter 106 is connected. However, the host 104 may be any other suitable processor-based unit and the port connecting the headset adapter to the host may be any other suitable communications port.

As shown, the host PC 104 includes an internal processor 122 such as a CPU that controls hardware and application software on the host. For example, the internal processor 122 may execute an application software 124 such as a training application, voice recognition application, music or other audio player application, video game application, video player application, and softphone application. The term softphone application generally refers to a telephony application running on a PC or other processor-based host.

The internal processor 122 may communicate via a port 126a with the external interface 112, e.g., keyboard and mouse. Similarly, the internal processor 122 may communicate via a port 126b directly and/or via a DAC/ADC 128 with the external applications 102. External applications 102 generally include any application external to the host 104 such as a display, DVD player, CD-ROM drive, CD-RW drive, microphone, and speakers. It is noted that such external applications 102 may not be physically external to the housing for host. For example, a CD-RW drive may be an internal drive housed in the same chassis as the internal processor 122. Furthermore, where the external application 102 is a digital application, the DAC/ADC 128 is not necessary to enable communication between the port 126b and the USB port 120. The communication between the port 126b and the USB port 120 bypassing the DAC/ADC 128 is represented by the dashed arrow therebetween.

The internal processor 122 may also communicate with the USB headset adapter 106 via the USB port 120 and the DAC/ADC 128. As is well known in the art, the DAC/ADC 128 is a digital-to-analog converter and an analog-to-digital converter that convert digital signals to analog signals and analog signals to digital signals. The USB headset adapter 106 includes a USB port 130 that communicates with and corresponds to the USB port 120 in the host 104.

The USB headset adapter 106 further includes a connector detect circuit 132, a DAC/ADC 134, and a processor or signaling circuit 136. The connector 108 that connects the headset 110 to the headset adapter 106 communicates with the connector detect circuit 132 and the DAC/ADC 134. The DAC/ADC 134 may facilitate in providing various features associated with the headset 110 such as volume control, tone control, treble boost, and/or bass boost. The adapter 106 may include integrated in-line controls (not shown) for controlling such features. Alternatively, such features may be integrated into a host-based software application. In RF applications, the DAC/ADC 134 may be internal to the headset 110 rather than to the adapter 106.

Headset connection status of connector 108 is determined by the connector detect circuit 132, i.e., whether the connector 108 is open or closed. Any suitable mechanism such as electronic state and/or mechanical detection mechanism may be employed by the detect circuit 132, the connector 108, and/or the processor 136 to detect the status of the connector 108. In particular, the connector detect circuit 132 or processor 136 either alone or in combination may passively or actively monitor the status of the headset connector 108. As an example of active monitoring, the connector detect circuit 132 may actively monitor the status of an electrical or mechanical switch provided in the connector 108 by polling the connector 108. The switch in the connector 108 may be configured such that the switch is closed when the connector 108 is closed and is open when the connector 108 is open. Thus, when the switch in the connector 108 is opened or closed, the connector detect circuit 132 detects the change as a result of the active polling.

Alternatively, the connector detect circuit 132 may passively monitor for changes in the status of the connector 108 such as by detecting a voltage change at the detect circuit 132 as a result of, for example, the switch in the connector 108 being opened or closed. In one preferred embodiment, the system 100 may be configured such that the voltage at the interface between the USB headset adapter 106 and the connector 108 is lower when the headset 110 is connected such that the monitoring of the this voltage level. In addition, depending upon the specific implementation, this voltage change itself may be sufficient to bypass the detection circuit straight into the processor. Alternatively, the status of the connector 108 may be detected by or otherwise passed directly to a pin of the processor 136 in the USB headset adapter 106, as shown by the dashed arrow in FIG. 2. As an example, the voltage change at the interface between the USB headset adapter 106 and the connector 108 may be sufficient to bypass the detection circuit 132 and be passed directly into the pin of the processor 136.

As yet another alternative embodiment, the internal processor 122 of the host 104 may poll the adapter 106 for the headset connection status through the USB ports 120, 130.

Regardless of how the status of the connector 108 is monitored, the processor 136 of the adapter 106 generates the digital headset connection status signal, the value of which depends upon the connection status of the headset. The digital headset status signal is preferably configured so as to be interpretable by the host and/or various application software products on the host. The value of the signal or flag indicating the headset connection status is changed when the connection status of the headset changes. The flag signal generated by the processor 136 is transmitted to the internal processor 122 of the PC host 104 via the USB ports 120, 130 of the PC host 104 and the USB adapter 106, respectively. Preferably, the flag signal is transmitted from the USB port 120 of the host PC 104 to the internal processor 122 via a direct path as illustrated by link 138.

The application software 124 executed by the internal processor 122 responds in response to changes in the headset connection status. Specifically, the application software 124 is configured to perform certain actions upon occurrence of a corresponding change in the headset connection status flag. In other words, depending on how the application and/or the host PC 104 are configured, the value of the status flag indicating the headset connection status determines which action(s) the application software 124 and/or host PC 104 perform. For example, when the flag signal is transmitted to the internal processor 122 of the PC host 104 indicating that the connector 108 is disconnected, the internal processor 122 may pause the execution of the application software 124 if the application software is running, may default to a screen saver mode regardless of whether the application software is running, and/or may prevent the application software from starting up if the application software is not running. Upon receiving the flag signal indicating that the connector 108 is reconnected, the internal processor 122 may return to actively running or executing the application software 124 if the application software was paused, may return to normal host operation from the screen saver mode if the host PC 104 was in screen saver mode, and/or may allow the application software to be started if the starting up of the application software was prevented. Thus, the processor-based host 104 and/or the application software 124 are responsive to changes in the headset connection status.

As noted above, the application software 124 executed by the internal processor 122 is configured to perform certain actions upon occurrence of a corresponding change in the headset connector status. Such actions are typically implemented or otherwise configured in the application software 124 and are performed when the host 104 is informed of the change in the headset connection status, i.e., whether the headset is in communication with the host. Detailed examples of actions performed in response to changes in the headset connection status will now be presented although any other suitable actions may be implemented in the application software and/or the host.

The application software 124 may implement a resource saving feature in which the host automatically powers down the puck when the headset is disconnected. Upon reconnection of the headset, the puck begins drawing power again. The resource saving feature preferably also freezes audio algorithms in order to prevent any divergence from settings established when the headset was in communication with the host. The resource saving feature facilitates in preserving power and thus is particularly useful in preserving battery life when the host is a laptop.

The application software 124 may also implement an audio file auto-pause feature. The audio file auto-pause feature automatically pauses the playing of the audio file, e.g., a CD or a .wave file, when the headset is disconnected and automatically resumes the playing of the audio file when the headset is reconnected. The audio file auto-pause feature may be useful, for example, where call center agents receive audio training between calls by providing convenience to the call center agents and by providing assurance to the supervisor that the agents are receiving and completing the training. The feature may also be useful when the user is listening to an audio file such as a book reading or music and allows the user to simply disconnect the headset without having to perform the extra step of manually and separately pausing the playing of the audio file.

Where the application software 124 is a video game application or any other application that is more than the mere playing of audio, the auto-pause feature preferably pauses the entire application. For instance, the user in the midst of a video game would simply disconnect the headset 110 at the connector 108 without having to also manually and separately pause the game.

Another feature that may be implemented by the application software 124 is a password auto-on feature that automatically freezes and password-protects the host and/or the application software when the headset is disconnected. The password auto-on feature provides added convenience by allowing the user such as a customer service agent to leave the station without having to separately and manually initiate password protection and/or to close open applications and files in order to ensure data integrity and security. Preferably, the time delay between the breaking of the headset connection and the password protection being automatically turned on is configurable, e.g., from a five to a thirty second delay.

The application software 124 may also implement a control module auto-disable feature. The control module auto-disable feature automatically disables in-line controls on a control module when the headset is disconnected and automatically enable the in-line controls when the headset is connected. Typically, the in-line controls on the control module include volume, mute, and hook switch controls. The control module may be integrated with the headset adapter 106 or may be physically separate from the adapter 106. The control module auto-disable feature would alleviate problems with in-line controls being unintentionally modified such as by being bumped or otherwise jostled or moved when the control module is disconnected from the headset.

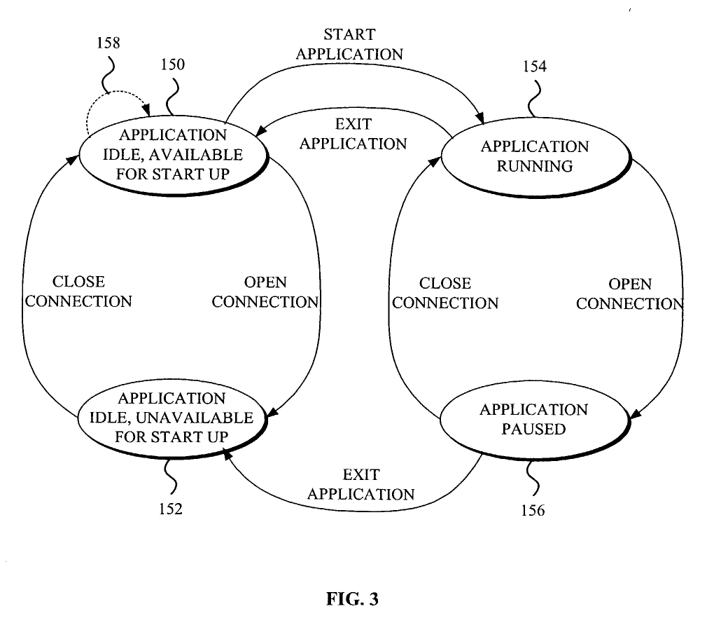

FIG. 3 is a state diagram illustrating exemplary states and state transitions for an application software running on a processor-based host and responsive to changes in headset connection status. Examples of application software include training application, voice recognition application, music or other audio player application, video game application, and video player application. In the example shown in FIG. 3, the application software is prevented from being started if the headset is disconnected and is paused if the headset is disconnected when the application is running. The application may be a voice recognition application, an audio player application, a video game application, or a video player application, for example. As shown, the application is idle and available for start up in state 150 where the headset connection is closed. Upon opening the headset connector, the application and host transition to an idle and unavailable state 152 where the application is prevented from being started up. Alternatively, the application may be configured such that it can be started up even when the headset connection is open, as shown by dashed arrow 158. In other words, the application and host would remain in the idle and available state 150 and state 152 would not exist.

When the application is started, the application and host transition from the idle and available state 150 to an application running state 154. The application and host transition from the application running state 154 to an application paused state 156 when the connection is opened and return to the application running state 154 when the connection is closed. In addition, the application and host may transition from the application running state 154 to the idle state 150 upon exiting the application when the connection is closed or from state 156 to state 152 upon exiting the application when the connection is open. As an example of an alternative configuration, the host may additionally or alternatively activate screen saver and/or password protection in the paused state 156. If password protection is invoked in the paused state 156, then password verification is required in addition to the closing of the connection in order to transition from the paused state 156 to the running state 154.

In one preferred exemplary embodiment, the application software is a training application software running a training session on the host where training audio is fed to a trainee through the headset. The training session is in one of a number of possible states and makes state transitions based upon the received headset connection status signals. For example, the training session application is idle and available for start up in state 150 where the headset connection is closed. Upon opening the headset connector, the training session application and host transition to the idle and unavailable state 152 where the training session application is prevented from being started up. Alternatively, the training session application may be configured such that it can be started up even when the headset connection is open, as shown by dashed arrow 158. In other words, the training session application and host would remain in the idle and available state 150 and state 152 would not exist.

When the training session application is started, the training session application and host transition from the idle and available state 150 to the training session running state 154. The training session application and host transition from the training session application running state 154 to the training session paused state 156 when the connection is opened as the trainee is not following the session once the headset is disconnected. The training session application and host return to the training session running state 154 to continue with the training session when the connection is closed or reconnected to allow the trainee to complete the session from where the training session was paused. The training session application and host may transition from the training session running state 154 to the idle state 150 upon exiting the training session application when the connection is closed or from state 156 to state 152 upon exiting the training session application when the connection is open. As an example of an alternative configuration, the host may additionally or alternatively activate screen saver and/or password protection in the paused state 156. If password protection is invoked in the training session paused state 156, then password verification is required in addition to the closing of the connection in order to transition from the training session paused state 156 to the running state 154.

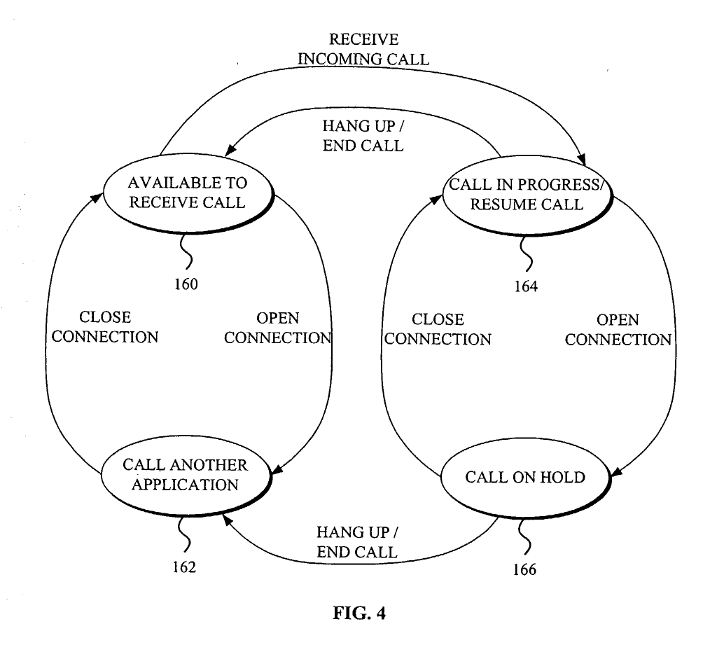

FIG. 4 is a state diagram illustrating exemplary states and state transitions for a softphone running on a processor-based host and responsive to changes in the headset connection status. It is noted that the possible state(s) when the application is idle are not shown for purposes of clarity but may be similar to that shown and described above with reference to states 150, 152 of FIG. 3.

As shown, when the application is currently not handling a call and is available to receive calls, the application and host are in an available state 160. The application and host transition from the available state 160 to a state 162 in which the softphone may call an answer feature in the softphone application or call another application such as an answer phone or speaker phone application upon receiving an incoming call when the connection is opened and return to the available state 160 when the connection is closed. In other words, in state 62, the softphone receives and answers an incoming call without routing the call to the headset. Alternatively, state 162 may be an unanswered ring state in which the softphone simply allows the call to ring unanswered.

From the available to receive call state 160, the application and host transition to call-in-progress state 164 when a call is routed to the host and application and thus become unavailable to receive additional calls. The application and host transition from the call-in-progress state 164 to call on hold state 166 when the connection is opened and return to the call-in-progress state 164 when the connection is closed. The application and host transition may alternatively transition from the call on hold state 166 to the unavailable state 162 such as when manual interaction with the softphone is made to end the call on hold, e.g., by opening the connection. In addition, the application and host may transition from the call-in-progress state 164 to the available state 160 upon ending the call and becoming available to receive the next call. As an example of an alternative configuration, the host may additionally or alternatively activate screen saver and/or password protection in the unavailable state 162 and/or the call on hold state 166 where the headset connection is open. If password protection is invoked, then password verification is required in addition to the closing of the headset connection in order to transition from state 162, 166 to state 160, 164, respectively.

As is evident, the digital headset connection status signaling system enables the user to interact automatically with the host PC by simply connecting or disconnecting the headset such as at a quick disconnect connector. Such automatic interaction with the host improves the efficiency of the user as well as the effectiveness of various software application products run by the host. It is noted that FIGS. 3 and 4 are not meant to exhaustively illustrate all possible states of the application and host but illustrate only exemplary states and state transitions typically associated with the opening and closing of the headset connection, i.e., the changes in the headset connection status.

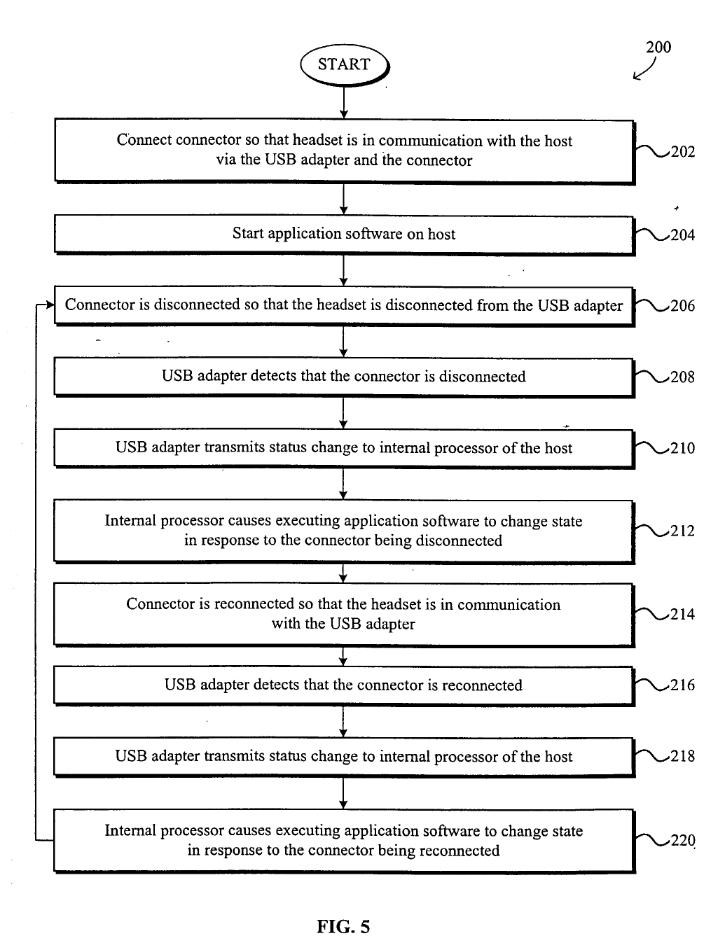

FIG. 5 is a flow chart illustrating an exemplary process 200 for detecting and responding to changes in the headset connection status by the host and/or the application running on the host. At step 202, the connector is closed so that the headset is in communication with the host via the connector and the USB adapter. Although not shown, the internal processor of the host receives or otherwise learns of the change in the headset connection status. At step 204, the application software is started to run on the processor-based host. As is evident, where the application software is configured such that it may be started with the headset disconnected, step 204 may precede step 202.

At step 206, the connector is disconnected so that the headset is no longer in communication with the USB adapter and thus no longer in communication with the host. At step 208, the USB adapter detects that the connector has been disconnected. As described above, the USB adapter may passively or actively monitor the headset connection status such as with the use of a processor and/or a connector detect circuit. At step 210, the USB adapter transmits a status change signal to the internal processor of the host. The USB adapter typically transmits a headset connection status flag signal either periodically or upon a change in the value of the flag. Alternatively, the internal processor of the host may actively monitor the headset connection status periodically by polling the USB connector. In addition, the headset connection status flag is preferably transmitted from the USB adapter to the internal processor via a direct link.

At step 212, the internal processor causes the executing application software and host to change state and thus perform certain actions in response to the connector being disconnected. For example, the execution of the application software may be paused in response to the connector being disconnected. Other examples of states and state transitions are shown and described above with reference to FIGS. 3 and 4.

At step 214, the connector is reconnected so that the headset is again in communication with the USB adapter 214. At step 216, the USB adapter detects that the connector has been reconnected and at step 218, the USB adapter transmits a status change signal to the internal processor of the host. At step 220, the internal processor causes the executing application software and the host to change state and thus perform certain actions in response to the connector being reconnected. For example, the execution of the application software may return to actively running or executing the application software if the application software was paused and/or return to normal host operation from screen saver mode if the host PC was in screen saver mode. Other examples of states and state transitions are shown and described above with reference to FIGS. 3 and 4. The process 200 then returns to step 206 when the connector is disconnected. The process 200 ends when running of the application on the host ends.

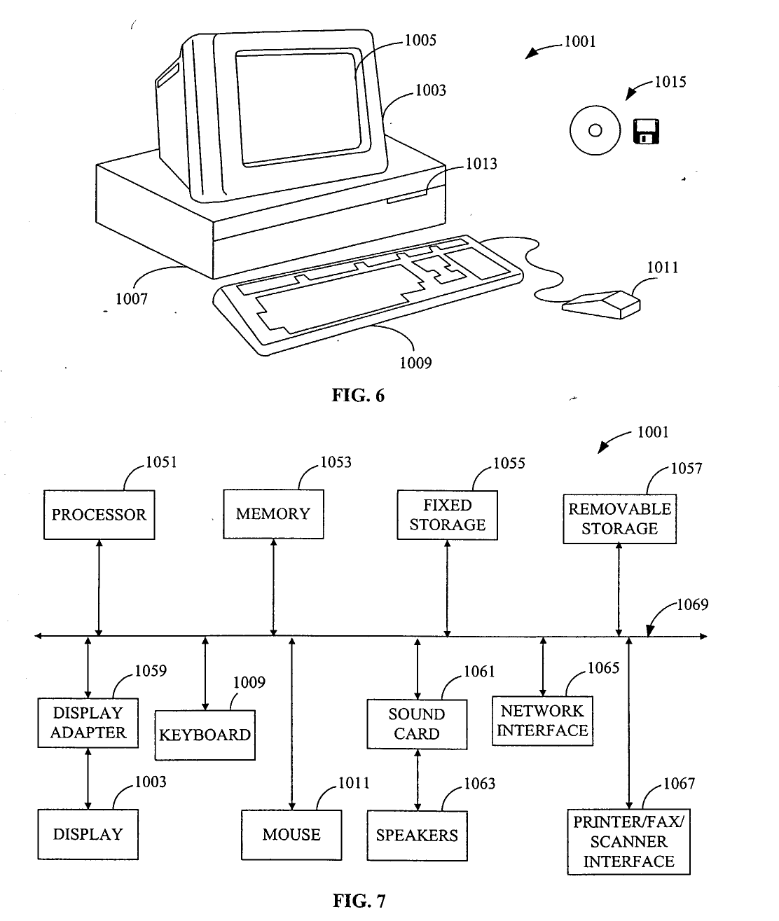

FIGS. 6 and 7 illustrate a schematic and a block diagram, respectively, of an exemplary general purpose computer system 1001 suitable for executing software programs that implement the methods and processes described herein. The architecture and configuration of the computer system 1001 shown and described herein are merely illustrative and other computer system architectures and configurations may also be utilized.

The exemplary computer system 1001 includes a display 1003, a screen 1005, a cabinet 1007, a keyboard 1009, and a mouse 1011. The cabinet 1007 typically houses one or more drives to read a computer readable storage medium 1015, a system memory 1053, and a hard drive 1055 which can be utilized to store and/or retrieve software programs incorporating computer codes that implement the methods and processes described herein and/or data for use with the software programs, for example. A CD and a floppy disk 1015 are shown as exemplary computer readable storage media readable by a corresponding floppy disk or CD-ROM or CD-RW drive 1013. Computer readable medium typically refers to any data storage device that can store data readable by a computer system. Examples of computer readable storage media include magnetic media such as hard disks, floppy disks, and magnetic tape, optical media such as CD-ROM disks, magneto-optical media such as floptical disks, and specially configured hardware devices such as application-specific integrated circuits (ASICs), programmable logic devices (PLDs), and ROM and RAM devices.

Further, computer readable storage medium may also encompass data signals embodied in a carrier wave such as the data signals embodied in a carrier wave carried in a network. Such a network may be an intranet within a corporate or other environment, the Internet, or any network of a plurality of coupled computers such that the computer readable code may be stored and executed in a distributed fashion.

The computer system 1001 comprises various subsystems such as a microprocessor 1051 (also referred to as a CPU or central processing unit), system memory 1053, fixed storage 1055 (such as a hard drive), removable storage 1057 (such as a CD-ROM drive), display adapter 1059, sound card 1061, transducers 1063 (such as speakers and microphones), network interface 1065, and/or printer/fax/scanner interface 1067. The computer system 1001 also includes a system bus 1069. However, the specific buses shown are merely illustrative of any interconnection scheme serving to link the various subsystems. For example, a local bus can be utilized to connect the central processor to the system memory and display adapter.

Methods and processes described herein may be executed solely upon CPU 1051 and/or may be performed across a network such as the Internet, intranet networks, or LANs (local area networks) in conjunction with a remote CPU that shares a portion of the processing.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. A method comprising the steps of:
monitoring a connection status of a headset for use with execution of an application software on a processor-based host device, the monitoring being performed by the host device based on whether the headset is in communication with the host device, the headset being in selective communication with the host device;
identifying a user availability to receive a call at the headset in response to the connection status of the headset, the user availability identified prior to receiving an incoming call at the processor-based host device;
determining a state with respect to the application software of at least one of the host device and the application software being executed on the host device in response to the connection status of the headset; and
causing one of the host device and the application software to be in the state as determined in response to the headset connection status.

2. The method of claim 1, wherein the host device is selected from the group consisting of a personal computer, a personal digital assistant, a digital music player, a video player, a video game player, and a processor-based telephone.

3. The method of claim 1, wherein the monitoring the connection status of a headset includes receiving a digital headset status signal formatted to enable communication of the headset status to the application software on the host device.

4. The method of claim 1, further comprising the step of executing the application software on the host device.

5. The method of claim 1, wherein determining that the headset is connected in the monitoring step when the application software is not executed on the host causes the host device to be in a first state that allows the application software to be executed on the host device.

6. The method of claim 5, wherein determining that the headset is disconnected in the monitoring step when the host is in the first state causes the host device to transition from the first state to a second state that prevents the application software from being executed on the host device.

7. The method of claim 1, wherein determining that the headset is disconnected in the monitoring step when the application software is being executed by the host device causes at least one of the host device and the application software to transition to a state that terminates execution of the application software.

8. The method of claim 1, wherein determining that the headset is disconnected in the monitoring step when the application software is being executed by the host device causes at least one of the host device and the application software to transition to a paused state that pauses the executing application software.

9. The method of claim 8, wherein determining that the headset is reconnected in the monitoring step when the application software is running in the paused state causes a transition from the paused state to an execution state that resumes execution of the application software.

10. The method of claim 9, wherein the state that resumes execution of the application software from the paused state resumes execution of the application software from where the execution of the application software was paused.

11. The method of claim 8, wherein the paused state additionally causes at least one of the host device and the application software to implement a resource saving feature to automatically power down the host device.

12. The method of claim 8, wherein the paused state additionally causes at least one of the host device and the application software to implement a password feature to automatically password-protect at least one of the host and the executing application software.

13. The method of claim 8, further comprising setting a control level associated with the headset in response to a control signal from a control module in communication with the host device, wherein the paused state additionally causes at least one of the host device and the application software to implement a control module auto-disable feature to automatically disable the controls on the control module.

14. The method of claim 13, wherein determining that the headset is reconnected in the monitoring step when the application software is running in the paused state causes a transition from the paused state to an execution state that resumes execution of the application software and that terminates the control module auto-disable feature so as to enable the controls on the control module.

15. The method of claim 13, wherein the controls of the control module is selected from the group consisting of controls for volume, mute, and hook switch controls.

16. The method of claim 1, wherein the headset is selectively in communication with the host device via one of a wired connection and a wireless connection.

17. The method of claim 1, wherein the application software is stored on a computer-readable medium.

18. The method of claim 1, wherein the application software is a softphone application software configured to handle telephone calls, and wherein the application software is idle when the softphone application is not handling a telephone call.

19. The method of claim 18, wherein determining that the headset is connected in the monitoring step when the softphone application software is idle causes the softphone application to be in an available state that allows the softphone application software to receive an incoming call.

20. The method of claim 19, wherein determining that the headset is disconnected in the monitoring step when the softphone application software is in the available state causes the softphone application software to transition to a state in which the softphone application software calls one of an answer phone application and a speaker phone application upon receiving an incoming call.

21. The method of claim 18, wherein determining that the headset is disconnected in the monitoring step when the softphone application is in a call-in-progress state with a call in progress causes the host device to transition to a hold state that places the call in progress on hold.

22. The method of claim 21, wherein determining that the headset is connected in the monitoring step when the application software is in the hold state causes a transition to the call-in-progress state.

23. A system for executing an application software, comprising:
a processor-based host for executing the application software;
a headset for use with execution of the application software on the host, the headset being in selective communication with the processor based host; and
an application software product containing the application software stored on a computer-readable medium,
wherein the processor-based host is adapted to monitor a connection status of the headset based on whether the headset is in communication with the host, to identify a user availability to receive a call at the headset in response to the connection status of the headset, the user availability identified prior to receiving an incoming call at the processor-based host device, to determine a state with respect to the application software of at least one of the host and the application software being executed on the host in response to the connection status of the headset, and to cause one of the host and the application software to be in the state as determined in response to the headset connection status, wherein the connection status monitored is whether the headset is mechanically connected if the headset is a wired headset or if the headset is detected if the headset is a wireless headset.

24. The system of claim 23, wherein the processor-based host is selected from the group consisting of a personal computer, a personal digital assistant, a digital music player, a video player, a video game player, and a processor-based telephone.

25. (canceled)

26. The system of claim 23, further comprising a connector having a headset portion coupled to the headset and a signaling module portion coupled to the signaling module, the headset portion and the signaling portion being configured to be selectively coupled and uncoupled to each other so as to selectively couple and uncouple the headset to the signaling module to enable and disable communication therebetween.

27. The system of claim 23, wherein upon determining that the headset is connected when the application software is not executed on the host causes the host to be in a first state that allows the application software to be executed on the host.

28. The system of claim 27, wherein upon determining that the headset is disconnected in the monitoring step when the host is in the first state causes the host to transition from the first state to a second state that prevents the application software from being executed on the host.

29. The system of claim 23, wherein upon determining that the headset is disconnected when the application software is being executed by the host causes at least one of the host and the application software to transition to a state that terminates execution of the application software.

30. The system of claim 23, wherein upon determining that the headset is disconnected when the application software is being executed by the host causes at least one of the host and the application software to transition to a paused state that pauses the executing application software.

31. The system of claim 30, wherein upon determining that the headset is reconnected when the application software is running in the paused state causes a transition from the paused state to an execution state that resumes execution of the application software.

32. The system of claim 31, wherein the state that resumes execution of the application software from the paused state resumes execution of the application software from where the execution of the application software was paused.

33. The system of claim 30, wherein the paused state additionally causes at least one of the host and the application software to implement a resource saving feature to automatically power down the host.

34. The system of claim 30, wherein the paused state additionally causes at least one of the host and the application software to implement a password feature to automatically password-protect at least one of the host and the executing application software.

35. The system of claim 30, further comprising a control module in communication with the host for setting a control level associated with the headset, wherein the paused state additionally causes at least one of the host and the application software to implement a control module auto-disable feature to automatically disable the controls on the control module.

36. The system of claim 35, wherein upon determining that the headset is reconnected when the application software is running in the paused state causes a transition from the paused state to an execution state that resumes execution of the application software and that terminates the control module auto-disable feature so as to enable the controls on the control module.

37. The system of claim 35, wherein the controls of the control module is selected from the group consisting of controls for volume, mute, and hook switch controls.

38. The system of claim 23, wherein the headset is selectively in communication with the processor-based host via one of a wired connection and a wireless connection.

39. The system of claim 23, wherein the application software is a softphone application software configured to handle telephone calls, and wherein the application software is idle when the softphone application is not handling a telephone call.

40. The system of claim 39, wherein upon determining that the headset is connected when the softphone application software is idle causes the softphone application to be in an available state that allows the softphone application software to receive an incoming call.

41. The system of claim 40, wherein upon determining that the headset is disconnected when the softphone application software is in the available state causes the softphone application software to transition to a state in which the softphone application software calls one of an answer phone application and a speaker phone application upon receiving an incoming call.

42. The system of claim 39, wherein upon determining that the headset is disconnected when the softphone application is in a call-in-progress state with a call in progress causes the host to transition to a hold state that places the call in progress on hold.

43. The system of claim 42, wherein upon determining that the headset is connected when the application software is in the hold state causes a transition to the call-in-progress state.
